(19) United States
(12) Patent Application Publication
(10) Pub. No.: US 2026/0181370 A1
(43) Pub. Date: Jun. 25, 2026

(54) SYSTEM AND METHOD FOR IMMW BEACON TRANSMISSION

(71) Applicant: NXP USA, Inc., AUSTIN, TX (US)

(72) Inventors: Liwen Chu, San Ramon, CA (US); Rui Cao, Sunnyvale, CA (US); Xiayu Zheng, San Jose, CA (US); Hongyuan Zhang, Fremont, CA (US)

(21) Appl. No.: 19/429,569

(22) Filed: Dec. 22, 2025

Related U.S. Application Data
(60) Provisional application No. 63/738,432, filed on Dec. 23, 2024.

(51) Int. Cl. H04W 8/00; H04W 16/28; H04W 56/00; H04W 84/12

(52) U.S. Cl. CPC H04W 8/005; H04W 16/28; H04W 56/0015; H04W 84/12

(57) ABSTRACT

Embodiments of a method and apparatus for wireless communications are disclosed. In an embodiment, a wireless device includes a controller configured to generate a null data packet (NDP) beacon frame, where the NDP beacon frame contains information regarding a beam sector used to transmit information for helping integrated millimeter wave (IMMW) access point (AP) discovery and beam tracking, and a wireless transceiver configured to transmit the NDP beacon frame in an IMMW link.

### CROSS-REFERENCE TO RELATED APPLICATIONS

This application is entitled to the benefit of U.S. Provisional Patent Application Ser. No. 63/738,432, filed on Dec. 23, 2024, the contents of which are incorporated by reference herein in their entireties.

### SUMMARY

Embodiments of a method and apparatus for wireless communications are disclosed. In an embodiment, a wireless device includes a controller configured to generate a null data packet (NDP) beacon frame, where the NDP beacon frame contains information regarding a beam sector used to transmit information for helping integrated millimeter wave (IMMW) access point (AP) discovery and beam tracking, and a wireless transceiver configured to transmit the NDP beacon frame in an IMMW link. Other embodiments are also disclosed.

In an embodiment, the information for helping the IMMW AP discovery and beam tracking in the NDP beacon frame contains an AP's identifier, remaining beacon information in a beacon burst, a beam identifier for transmitting the NDP beacon frame, information regarding partial timing synchronization function (TSF) time, and critical update indication information.

In an embodiment, the critical update indication information includes an indication regarding whether an access point (AP) multi-link device (MLD) or an AP affiliated with the AP MLD has a critical update.

In an embodiment, the wireless device includes a wireless AP, and the AP's identifier includes a basic service set (BSS) color of the wireless AP.

In an embodiment, NDP beacon frames in the beacon burst are transmitted at each target beacon transmission time (TBTT) of the IMMW link.

In an embodiment, without a negotiation from either an associated non-AP multi-link device (MLD) or an unassociated station (STA) MLD, the NDP beacon frames in the beacon burst are transmitted using transmission beams agreed by associated STA MLDs.

In an embodiment, with a successful negotiation from either an associated non-AP multi-link device (MLD) or an unassociated station (STA) MLD, the NDP beacon frames in the beacon burst are transmitted using all transmission beams of an IMMW AP at a negotiated TBTT.

In an embodiment, the successful negotiation is performed by a non-AP MLD's NDP beacon request and an AP MLD's NDP beacon response with a successful indication that is solicited by the NDP beacon request.

In an embodiment, NDP beacon frames in the beacon burst are transmitted at a negotiated target beacon transmission time (TBTT) of the IMMW link.

In an embodiment, with a successful negotiation from either an associated non-AP multi-link device (MLD) or an unassociated station (STA) MLD, the NDP beacon frames in the beacon burst are transmitted using all transmission beams of an IMMW AP at the negotiated TBTT.

In an embodiment, the successful negotiation is performed by a non-AP MLD's NDP beacon request and an AP MLD's NDP beacon response with a successful indication that is solicited by the NDP beacon request.

In an embodiment, the IMMW link includes a 45 Gigahertz (GHz) link or a 60 GHz link.

In an embodiment, the wireless device is compatible with an Institute of Electrical and Electronics Engineers (IEEE) 802.11 protocol.

In an embodiment, a wireless access point (AP) multi-link device (MLD) includes a controller configured to generate a null data packet (NDP) beacon frame, where the NDP beacon frame contains AP identifier information, information regarding a beam sector used to transmit the NDP beacon frame, and beacon burst remaining beacon frame information, and a wireless transceiver configured to transmit the NDP beacon frame in an integrated millimeter wave (IMMW) link established between the wireless AP MLD and a non-AP station (STA) MLD.

In an embodiment, a method for wireless communications involves at a wireless device, generating a null data packet (NDP) beacon frame, where the NDP beacon frame contains information regarding a beam sector used to transmit information for helping integrated millimeter wave (IMMW) access point (AP) discovery and beam tracking, and at the wireless device, transmitting the NDP beacon frame in an IMMW link.

In an embodiment, the information for helping the IMMW AP discovery and beam tracking in the NDP beacon frame contains an AP's identifier, remaining beacon information in a beacon burst, a beam identifier for transmitting the NDP beacon frame, information regarding partial timing synchronization function (TSF) time, and critical update indication information.

In an embodiment, the critical update indication information includes an indication regarding whether an access point (AP) multi-link device (MLD) or an AP affiliated with the AP MLD has a critical update.

In an embodiment, the wireless device includes a wireless AP, and the AP's identifier includes a basic service set (BSS) color of the wireless AP.

In an embodiment, NDP beacon frames in the beacon burst are transmitted at each target beacon transmission time (TBTT) of the IMMW link.

In an embodiment, without a negotiation from either an associated non-AP multi-link device (MLD) or an unassociated station (STA) MLD, the NDP beacon frames in the beacon burst are transmitted using transmission beams agreed by associated STA MLDs.

Other aspects in accordance with the disclosure will become apparent from the following detailed description, taken in conjunction with the accompanying drawings, illustrated by way of example of the principles of the disclosure.

### BRIEF DESCRIPTION OF THE DRAWINGS

FIG. 1 depicts a wireless communications system in accordance with example embodiments.

FIG. 2 depicts a multi-link (ML) communications system that is used for wireless communications in accordance with an embodiment of the disclosure.

FIG. 3 depicts a multi-link (ML) communications system in accordance with example embodiments.

FIG. 4 depicts a wireless device in accordance with example embodiments.

FIG. 5A illustrates an NDP beacon frame format in accordance with example embodiments.

FIG. 5B illustrates an NDP beacon frame format in accordance with example embodiments.

FIG. 6 illustrates a periodic NDP beacon transmission in accordance with example embodiments.

FIG. 7 illustrates an on-demand NDP beacon transmission in accordance with example embodiment.

FIG. 8 illustrates an on-demand NDP beacon transmission in accordance with example embodiments.

FIG. 9 is a process flow diagram of a method for wireless communications in accordance with example embodiments.

Throughout the description, similar reference numbers may be used to identify similar elements.

### DETAILED DESCRIPTION

Wireless communications devices, e.g., access points (APs) or non-AP devices transmit various types of information using different transmission techniques. For example, various applications, such as, Internet of Things (IoT) applications conduct wireless local area network (WLAN) communications, for example, based on Institute of Electrical and Electronics Engineers (IEEE) 802.11 family of standards (e.g., Wi-Fi standards). Some applications, for example, video teleconferencing, streaming entertainment, high definition (HD) video surveillance applications, outdoor video sharing applications, etc., require relatively high system throughput. To facilitate the proper data transmission within a wireless communications system, there is a need for wireless communications technology that can efficiently and securely convey wireless communications information, for example, information related to data, communications links, and/or wireless devices (e.g., operation and/or capability parameters of wireless devices) within the wireless communications system.

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Thus, discussions of the features and advantages, and similar language, throughout this specification may, but do not necessarily, refer to the same embodiment.

Furthermore, the described features, advantages, and characteristics of the disclosure may be combined in any suitable manner in one or more embodiments. One skilled in the relevant art will recognize, in light of the description herein, that the disclosure can be practiced without one or more of the specific features or advantages of a particular embodiment. In other instances, additional features and advantages may be recognized in certain embodiments that may not be present in all embodiments of the disclosure.

Reference throughout this specification to “one embodiment”, “an embodiment”, or similar language means that a particular feature, structure, or characteristic described in connection with the indicated embodiment is included in at least one embodiment of the present disclosure. Thus, the phrases “in one embodiment”, “in an embodiment”, and similar language throughout this specification may, but do not necessarily, all refer to the same embodiment.

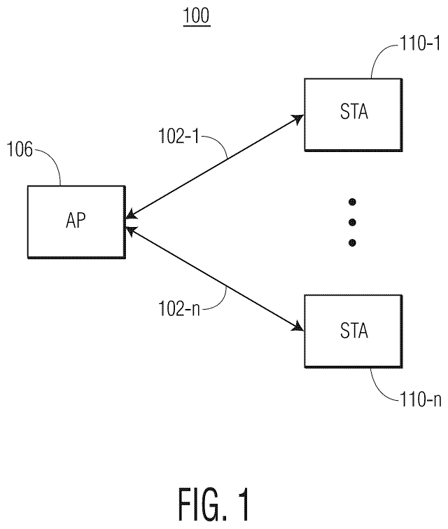

FIG. 1 depicts a wireless (e.g., WiFi) communications system 100 in accordance with an embodiment of the disclosure. In the embodiment depicted in FIG. 1, the wireless communications system 100 includes at least one AP 106 and at least one station (STA) 110-1, . . . , 110-n, where n is a positive integer. The wireless communications system can be used in various applications, such as industrial applications, medical applications, computer applications, and/or consumer or enterprise applications. In some embodiments, the wireless communications system is compatible with an IEEE 802.11 protocol. Although the depicted wireless communications system 100 is shown in FIG. 1 with certain components and described with certain functionality herein, other embodiments of the wireless communications system may include fewer or more components to implement the same, less, or more functionality. For example, in some embodiments, the wireless communications system includes multiple APs with multiple STAs, one AP with one STA, or one AP with multiple STAs. In another example, although the wireless communications system is shown in FIG. 1 as being connected in a certain topology, the network topology of the wireless communications system is not limited to the topology shown in FIG. 1. In some embodiments, the wireless communications system 100 described with reference to FIG. 1 involves single-link communications and the AP and the STA communicate through single communications link. In some embodiments, the AP 106 may be affiliated with an AP MLD, and a STA 100-j with j being an integer equal to one of 1 to n may be affiliated with a STA MLD j (=non-AP MLD j).

In the embodiment depicted in FIG. 1, the AP 106 may be implemented in hardware (e.g., circuits), software, firmware, or a combination thereof. The AP 106 may be fully or partially implemented as an integrated circuit (IC) device. In some embodiments, the AP 106 is a wireless AP compatible with at least one WLAN communications protocol (e.g., an IEEE 802.11bq protocol). In some embodiments, the AP is a wireless AP that connects to a local area network (LAN) and/or to a backbone network (e.g., the Internet) through a wired connection and that wirelessly connects to one or more wireless stations (STAs), for example, through one or more WLAN communications protocols, such as the IEEE 802.11 protocol. In some embodiments, the AP includes at least one antenna, at least one transceiver operably connected to the at least one antenna, and at least one controller operably connected to the corresponding transceiver. In some embodiments, the transceiver includes a physical layer (PHY) device. The controller may be configured to control the transceiver to process received packets through the antenna. In some embodiments, the controller is implemented within a processor, such as a microcontroller, a host processor, a host, a digital signal processor (DSP), or a central processing unit (CPU), which can be integrated in a corresponding transceiver. In some embodiments, the AP 106 (e.g., a controller or a transceiver of the AP) implements upper layer Media Access Control (MAC) functionalities (e.g., beacon, association establishment, reordering of frames, etc.) and/or lower layer MAC functionalities (e.g., backoff, frame transmission, frame reception, etc.). Although the wireless communications system 100 is shown in FIG. 1 as including one AP, other embodiments of the wireless communications system 100 may include multiple APs. In these embodiments, each of the APs of the wireless communications system 100 may operate in a different frequency band. For example, one AP may operate in a 2.4 gigahertz (GHz) frequency band and another AP may operate in a 5 GHz frequency band.

In the embodiment depicted in FIG. 1, each of the at least one STA 110-1, . . . , 110-n may be implemented in hardware (e.g., circuits), software, firmware, or a combination thereof. The STA 110-1, . . . , or 110-n may be fully or partially implemented as IC devices. In some embodiments, the STA 110-1, . . . , or 110-n is a communication device compatible with at least one IEEE 802.11 protocol. In some embodiments, the STA 110-1, . . . , or 110-n is implemented in a laptop, a desktop personal computer (PC), a mobile phone, or other communications device that supports at least one WLAN communications protocol. In some embodiments, the STA 110-1, . . . , or 110-n implements upper layer MAC functionalities and lower layer MAC layer functionalities. In some embodiments, the STA 110-1, . . . , or 110-n includes at least one antenna, at least one transceiver operably connected to the at least one antenna, and at least one controller connected to the corresponding transceiver. In some embodiments, the transceiver includes a PHY device. The controller may be configured to control the transceiver to process received packets through the antenna. In some embodiments, the controller is implemented within a processor, such as a microcontroller, a host processor, a host, a DSP, or a CPU, which can be integrated in a corresponding transceiver.

In the embodiment depicted in FIG. 1, the AP 106 communicates with the at least one STA 110-1, . . . , 110-n via a communication link 102-1, . . . , 102-n, where n is a positive integer. In some embodiments, data communicated between the AP and the at least one STA 110-1, . . . , 110-n includes MAC protocol data units (MPDUs). An MPDU may include a frame header, a frame body, and a trailer with the MPDU payload encapsulated in the frame body.

In some embodiments of a wireless communications system, a wireless device, e.g., an access point (AP) multi-link device (MLD) of a wireless local area network (WLAN) may transmit data to at least one associated station (STA) MLD. The AP MLD may be configured to operate with associated STA MLDs according to a communication protocol. For example, the communication protocol may be an integrated mmWave (IMMW) communication protocol, or an Institute of Electrical and Electronics Engineer (IEEE) 802.11 communication protocol (e.g., an IEEE 802.11bq communication protocol). In some embodiments of the wireless communications system described herein, different associated STAs within range of an AP operating according to the IMMW communication protocol are configured to operate also according to at least one other communication protocol. The other communication protocols (e.g., Ultra High Reliability communication protocol, Extremely High Throughput (EHT) communication protocol that is compatible with IEEE 802.11be standards, High Efficiency (HE) communication protocol that is compatible with IEEE 802.11ax standards, Very High Throughput (VHT) communication protocol that is compatible with IEEE 802.11ac standards, etc.) may be collectively referred to herein as “legacy” communication protocols.

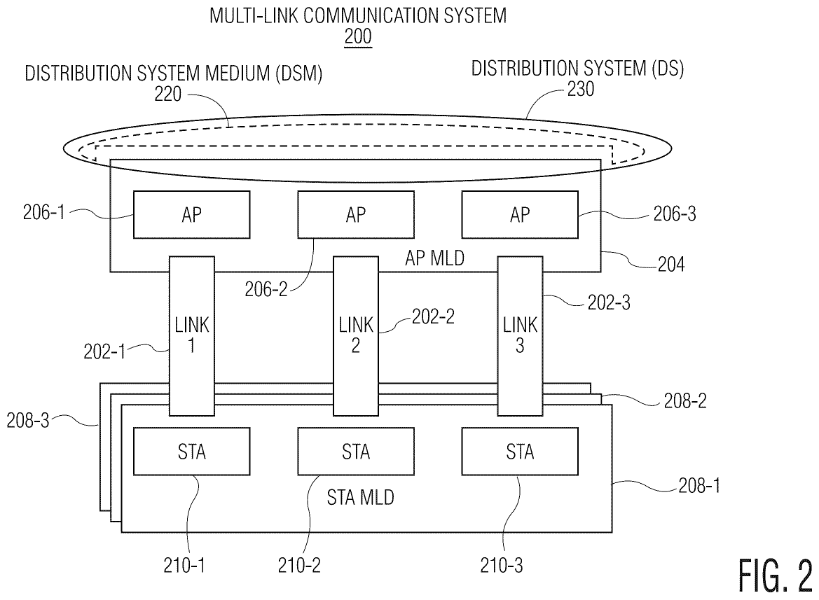

FIG. 2 depicts a multi-link (ML) communications system 200 that is used for wireless (e.g., WiFi) communications in accordance with example embodiments. In the embodiment depicted in FIG. 2, the multi-link communications system includes at least one AP multi-link device (MLD) 204, and one or more non-AP multi-link devices, which are, for example, implemented as station (STA) MLDs 208-1, 208-2, 208-3. The multi-link communications system can be used in various applications, such as industrial applications, medical applications, computer applications, and/or consumer or appliance applications. In some embodiments, the multi-link communications system is a wireless communications system, such as a wireless communications system compatible with the Institute of Electrical and Electronics Engineers (IEEE) 802.11bq protocol. Although the depicted multi-link communications system 200 is shown in FIG. 2 with certain components and described with certain functionality herein, other embodiments of the multi-link communications system 200 may include fewer or more components to implement the same, less, or more functionality. For example, although the multi-link communications system 200 is shown in FIG. 2 includes the AP MLD 204 and the STA MLDs 208-1, 208-2, 208-3, in other embodiments, the multi-link communications system includes other multi-link devices, such as, multiple AP MLDs and multiple STA MLDs, multiple AP MLDs and a single STA MLD, a single AP MLD and a single STA MLD. In another example, in some embodiments, the multi-link communications system includes more than three STA MLDs and/or less than three STA MLDs. In yet another example, although the multi-link communications system 200 is shown in FIG. 2 as being connected in a certain topology, the network topology of the multi-link communications system 200 is not limited to the topology shown in FIG. 2.

In the embodiment depicted in FIG. 2, the AP MLD 204 includes three APs in three links, implemented as APs 206-1, 206-2, 206-3. In some embodiments, the AP MLD 204 is an AP multi-link logical device. In some embodiments, a common part of the AP MLD 204 implements upper layer Media Access Control (MAC) functionalities common to multiple links (e.g., association establishment, reordering of frames, etc.) and a link specific part of the AP MLD 204, i.e., the APs 206-1, 206-2, 206-3, implement the upper layer MAC functionalities specific for a link and the lower layer MAC functionalities specific for a link (e.g., beaconing, backoff, frame transmission, frame reception, etc.). The APs 206-1, 206-2, 206-3 may be implemented in hardware (e.g., circuits), software, firmware, or a combination thereof. At least one of the APs 206-1, 206-2, 206-3 may be fully or partially implemented as an integrated circuit (IC) device. In some embodiments, the APs 206-1, 206-2, 206-3 are compatible with at least one wireless local area network (WLAN) communications protocol (e.g., at least one IEEE 802.11 protocol). For example, the APs 206-1, 206-2, 206-3 may be wireless APs compatible with at least one IEEE 802.11bn protocol. In some embodiments, an AP MLD (e.g., AP MLD 204) connects to a local network (e.g., a LAN) and/or to a backbone network (e.g., the Internet) through a wired connection and wirelessly connects to wireless STAs, for example, through one or more WLAN communications protocols, such as an IEEE 802.11 protocol. In some embodiments, an AP (e.g., the AP 206-1, the AP 206-2, and/or the AP 206-3) includes at least one antenna, at least one transceiver operably connected to the at least one antenna, and at least one controller operably connected to the corresponding transceiver. In some embodiments, at least one transceiver includes a physical layer (PHY) device. The at least one controller may be configured to control the at least one transceiver to process received packets through the at least one antenna. In some embodiments, the at least one controller may be implemented within a processor, such as a microcontroller, a host processor, a host, a digital signal processor (DSP), or a central processing unit (CPU), which can be integrated in a corresponding transceiver. In some embodiments, each of the APs 206-1, 206-2, 206-3 of the AP MLD 204 operates in a different BSS operating channel. For example, at least one of the APs 206-1, 206-2, 206-3 of the AP MLD 204 operates in an integrated mmWave (IMMW, i.e., Integrated millimeter wave) frequency band or a non-IMMW (i.e. sub-7 GHz or <7 GHz) frequency band. In some embodiments, the mmWave frequency band is a frequency band between 20 Gigahertz (GHz) and 300 GHz. For example, the mmWave frequency band is a frequency band above 45 GHZ, e.g., a 60 GHz frequency band. For example, the AP 206-1 may operate at 6 Gigahertz (GHz) band (e.g., in a 320 MHz (one million hertz) Basic Service Set (BSS) operating channel or other suitable BSS operating channel), the AP 206-2 may operate at 5 GHz band (e.g., a 160 MHz BSS operating channel or other suitable BSS operating channel), and the AP 206-3 may operate at 60 GHz band (e.g., a 320 MHz, 640 MHz BSS operating channel or other suitable BSS operating channel). In the embodiment depicted in FIG. 2, the AP MLD is connected to a distribution system (DS) 230 through a distribution system medium (DSM) 220. The distribution system (DS) 230 may be a wired network or a wireless network that is connected to a backbone network such as the Internet. The DSM 220 may be a wired medium (e.g., Ethernet cables, telephone network cables, or fiber optic cables) or a wireless medium (e.g., infrared, broadcast radio, cellular radio, or microwaves). Although the AP MLD 204 is shown in FIG. 2 as including three APs, other embodiments of the AP MLD 204 may include fewer than three APs or more than three APs. In addition, although some examples of the DSM 220 are described, the DSM 220 is not limited to the examples described herein.

In the embodiment depicted in FIG. 2, the STA MLD 208-1 includes multiple non-AP stations (STAs) 210-1, 210-2, 210-3. The STAs 210-1, 210-2, 210-3 may be implemented in hardware (e.g., circuits), software, firmware, or a combination thereof. The STAs 210-1, 210-2, 210-3 may be fully or partially implemented as an IC device. In some embodiments, the non-AP STAs 210-1, 210-2, 210-3 are part of the STA MLD 208-1, such that the STA MLD may be a communications device that wirelessly connects to a wireless AP MLD, such as, the AP MLD 204. For example, the STA MLD 208-1 (e.g., at least one of the non-AP STAs 210-1, 210-2, 210-3) may be implemented in a laptop, a desktop personal computer (PC), a mobile phone, or other communications device that supports at least one WLAN communications protocol. In some embodiments, the non-AP STA MLD 208-1 is a communications device compatible with at least one IEEE 802.11 protocol (e.g., an IEEE 802.11bq protocol, an IEEE 802.11 bn protocol, an IEEE 802.11be protocol, an IEEE 802.11ax protocol, or an IEEE 802.11ac protocol). In some embodiments, each of the non-AP STAs 210-1, 210-2, 210-3 includes at least one antenna, at least one transceiver operably connected to the at least one antenna, and at least one controller connected to the corresponding transceiver. In some embodiments, the at least one transceiver includes a PHY device. The at least one controller operably may be configured to control the at least one transceiver to process received packets through the at least one antenna. In some embodiments, the at least one controller is implemented within a processor, such as a microcontroller, a host processor, a host, a DSP, or a CPU, which can be integrated in a corresponding transceiver. In some embodiments, the STA MLD has one MAC data service interface. In an embodiment, a single address is associated with the MAC data service interface and is used to communicate on the DSM 220. In some embodiments, the STA MLD 208-1 implements a common MAC upper layer functionalities and the non-AP STAs 210-1, 210-2, 210-3 implement a link specific upper layer functionalities and a lower layer MAC functionalities. In some embodiments, the AP MLD 204 and/or the STA MLDs 208-1, 208-2, 208-3 identify which communications links support the multi-link operation during a multi-link operation setup phase and/or exchanges information regarding multi-link capabilities during the multi-link operation setup phase. Each of the STAs 210-1, 210-2, 210-3 of the STA MLD may operate in a different frequency band. For example, at least one of the STAs 210-1, 210-2, 210-3 of the STA MLD 208-1 operates in the IMMW (i.e. mmWave) frequency band (e.g. in a 320 MHz or 640 MHz operating channel). In some embodiments, the mmWave frequency band is a frequency band between 20 GHz and 300 GHz. For example, the mmWave frequency band is a frequency band above 45 GHZ, e.g., a 60 GHz frequency band. For example, the STA 210-1 may operate at 6 GHz band (e.g., in a 320 MHz (one million hertz) BSS operating channel or other suitable BSS operating channel), the STA 210-2 may operate at 5 GHz band (e.g., a 160 MHz BSS operating channel or other suitable BSS operating channel), and the STA 210-3 may operate at 60 GHz band (e.g., a 320 MHz BSS operating channel, a 640 MHz BSS operating channel, or other suitable BSS operating channel). Although the STA MLD 208-1 is shown in FIG. 1 as including three non-AP STAs, other embodiments of the STA MLD 208-1 may include fewer than three non-AP STAs or more than three non-AP STAs.

Each of the MLDs 208-2, 208-3 may be the same as or similar to the MLD 208-1. For example, the MLD 208-2 or 208-3 includes multiple non-AP STAs. In some embodiments, each of the non-AP STAs includes at least one antenna, at least one transceiver operably connected to the at least one antenna, and at least one controller connected to the corresponding transceiver. In some embodiments, the at least one transceiver includes a PHY device. The at least one controller operably may be configured to control the at least one transceiver to process received packets through the at least one antenna. In some embodiments, the at least one controller is implemented within a processor, such as a microcontroller, a host processor, a host, a DSP, or a CPU, which can be integrated in a corresponding transceiver.

In the embodiment depicted in FIG. 2, the STA MLD 208-1 communicates with the AP MLD 204 through multiple communications links 202-1, 202-2, 202-3. For example, each of the STAs 210-1, 210-2, 210-3 communicates with an AP 206-1, 206-2, or 206-3 through a corresponding communications link 202-1, 202-2, or 202-3. In an embodiment, a communication link (e.g., the communications link 202-1, the communications link 202-2, or the communications link 202-3) other than an mmWave link may include a BSS operating channel established by an AP (e.g., the AP 206-1, the AP 206-2, or the AP 206-3) that features multiple 20 MHz channels used to transmit frames (e.g., beacon frames, management frames, etc., in Physical Layer Protocol Data Units (PPDUs)) between a first wireless device (e.g., an AP, an AP MLD, an STA, or an STA MLD) and a second wireless device (e.g., an AP, an AP MLD, an STA, or an STA MLD). In some embodiments, a 20 MHz channel covered by the BSS operating channel may be a punctured 20 MHz channel or an unpunctured 20 MHz channel. Although the AP MLD 204 communicates (e.g., wirelessly communicates) with the STA MLD 208-1 through multiple links 202-1, 202-2, 202-3, in other embodiments, the AP MLD 204 may communicate (e.g., wirelessly communicate) with the STA MLD through more than three communications links or less three than communications links. In some embodiments, a communication link (e.g., the communications link 202-1, the communications link 202-2, or the communications link 202-3) that is a mmWave link may include a BSS operating channel established by an AP (e.g., the AP 206-1, the AP 206-2, or the AP 206-3) that features one 320 MHz channel or two 320 MHz channels. The communications links in the multi-link communications system may include multiple mmWave links and one non-mmWave link, multiple mm Wave links and multiple non-mmWave links, one mmWave link and multiple non-mm Wave links, or one mmWave link and one non-mmWave link. For example, in the embodiment depicted in FIG. 1, the communications links 202-1, 202-2, 202-3 between the AP MLD 204 and the STA MLD 208-1 involve at least one mmWave link. For example, the communications links 202-1, 202-2, 202-3 between the AP MLD 204 and the STA MLD 208-1 include an mmWave link (e.g., a 45/60 GHz link) between an AP of the AP MLD 204 and an STA of the STA MLD 208-1 operating in an mmWave frequency band (e.g., a 45/60 GHz frequency band) and two non-mm Wave links (e.g., 2.4 GHz, 5 GHZ, or 6 GHz links) and two non-mmWave links (e.g., a 2.4 GHz, 5 GHz, or 6 GHz link) between APs of the AP MLD 204 and STAs of the STA MLD 208-1 operating in non-mm Wave frequency bands (e.g., 2.4 GHz, 5 GHZ, or 6 GHz frequency bands). In another example, the communications links 202-1, 202-2, 202-3 between the AP MLD 204 and the STA MLD 208-1 include two mmWave links (e.g., 45/60 GHz links) between APs of the AP MLD 204 and STAs of the STA MLD 208-1 operating in mmWave frequency bands (e.g., 45/60 GHz frequency bands) and one non-mmWave link (e.g., a 2.4 GHz, 5 GHZ, or 6 GHz link) between an AP of the AP MLD 204 and an STA of the STA MLD 208-1 operating in a non-mm Wave frequency bands (e.g., a 2.4 GHZ, 5 GHZ, or 6 GHz frequency band). The control and management of the MLD and an mmWave link, for example, a 45 GHz/60 GHz link may be performed in a non-mmWave link, for example, a 2.4 GHz, 5 GHz, or 6 GHz link. For example, the association of a non-AP MLD with an mmWave link can be done or conducted through a non-mmWave MHz link. However, beaconing and channel switch can be challenging for a MLD system with one or more mmWave links.

In some embodiments, a first MLD, e.g., an AP MLD or non-AP MLD (STA MLD), may transmit MLD-level management frames in a non-mmWave link for a multi-link operation with a second MLD, e.g., STA MLD or AP MLD, to coordinate the multi-link operation between the first MLD and the second MLD. As an example, a management frame may be a Traffic Identifier (TID)-to-Link Mapping frame, a (Re) Association Request frame, a (Re) Association Response frame, a Disassociation frame, an Authentication frame, and/or a Block Acknowledgement (Ack) (BA) Action frame, etc. In some embodiments, an AP/STA of a first MLD may transmit link-level management frames for a link to a STA/AP of a second MLD. In some embodiments, one or more link-level management frames for a link may be transmitted via the link or via a cross-link transmission (e.g., according to an IEEE 802.11bn communication protocol) where the frame for a link is transmitted in another link. As an example, a cross-link management frame transmission for a mmWave link may involve a management frame being transmitted and/or received on one non-mmWave link (e.g., the link 1 202-1) while carrying information of the mm Wave link (e.g., the link 2 202-2). In some embodiments, a management frame is transmitted on any link (e.g., at least one of two links or at least one of multiple links) between a first MLD (e.g., the AP MLD 204) and a second MLD (e.g., the STA MLD 208). As an example, a management frame may be transmitted between a first MLD and a second MLD on any link (e.g., at least one of two links or at least one of multiple links) associated with the first MLD and the second MLD.

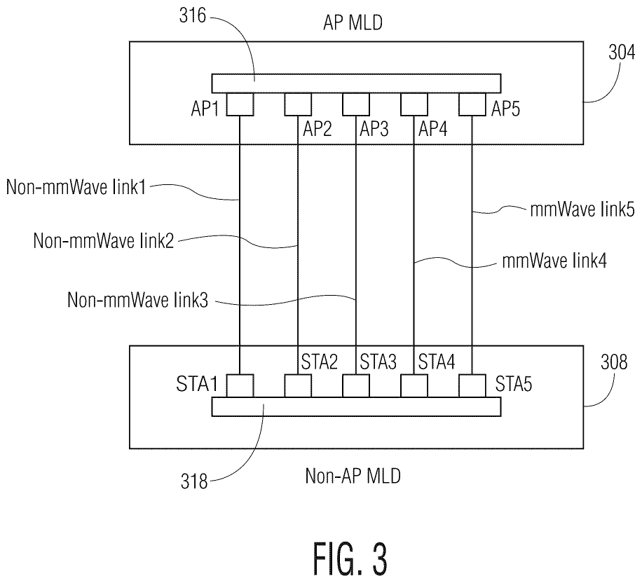

FIG. 3 depicts a multi-link (ML) communications system 300 in accordance with example embodiments. In the embodiment depicted in FIG. 3, the ML communications system 300 includes an AP MLD 304, which includes a common MAC controller 316 and five wireless APs AP1, AP2, AP3, AP4, AP5 and a non-AP MLD 308, which includes a common MAC controller 318 and five wireless STAs STA1, STA2, STA3, STA4, STA5. In some embodiments, the common MAC controller 316 implements upper layer MAC functionalities common for multiple links (e.g., association establishment, reordering of frames, etc.) of the AP MLD 304 and a link specific part of the AP MLD 304, i.e., AP1, AP2, AP3, AP4, AP5, implements the upper layer functionalities for a link and lower layer MAC functionalities for a link (e.g., beaconing, backoff, frame transmission, frame reception, etc.) of the AP MLD 304. In some embodiments, the common MAC controller 318 implements upper layer MAC functionalities for multiple links (e.g., association establishment, reordering of frames, etc.) of the non-AP MLD 304 and a link specific part of the non-AP MLD 308, i.e., STA1, STA2, STA3, STA4, STA5, implements upper layer MAC functionalities for a link and lower layer MAC functionalities for a link (e.g., Beaconing, backoff, frame transmission, frame reception, etc.) of the non-AP MLD 308. The ML communications system 300 depicted in FIG. 3 is an embodiment of the ML communications system 200 depicted in FIG. 2. However, the ML communications system 200 depicted in FIG. 2 is not limited to the embodiment shown in FIG. 3. For example, the AP MLD 304 depicted in FIG. 3 is an embodiment of the AP MLD 204 depicted in FIG. 2. However, the AP MLD 204 depicted in FIG. 2 is not limited to the embodiment shown in FIG. 3. In addition, the non-AP MLD 308 depicted in FIG. 3 is an embodiment of the non-AP MLDs 208-1, 208-2, 208-3 depicted in FIG. 2. However, the non-AP MLDs 208-1, 208-2, 208-3 depicted in FIG. 2 are not limited to the embodiment shown in FIG. 3. In the embodiment depicted in FIG. 3, a non-mm Wave link (e.g., a 2.4/5/6 GHz band link), which is referred to as the non-mmWave link1, is between AP1 and STA1, which both operate in a non-mmWave frequency band (e.g., a 2.4 GHz, 5 GHZ, or 6 GHz frequency band) and are capable of non-mmWave communications, a non-mmWave link (e.g., a 2.4/5/6 GHz band link), which is referred to as the non-mmWave link2, is between AP2 and STA2, which both operate in a non-mm Wave frequency band (e.g., a 2.4 GHz, 5 GHZ, or 6 GHz frequency band) and are capable of non-mmWave communications, an mm Wave link (e.g., a 45 GHz IMMW link or a 60 GHz IMMW link), which is referred to the mmWave link3, is between AP3 and STA3, which both operate in an mmWave frequency band (e.g., a 45 GHz or 60 GHz frequency band) and are capable of mmWave communications, an mmWave link (e.g., a 45 GHz IMMW link or a 60 GHz IMMW link), which is referred to the mm Wave link4, is between AP4 and STA4, which both operate in an mmWave frequency band (e.g., a 45 GHz or 60 GHz frequency band) and are capable of mmWave communications, and an mmWave link (e.g., a 45 GHz IMMW link or a 60 GHz IMMW link), which is referred to the mmWave link5, is between AP5 and STA5, which both operate in an mmWave frequency band (e.g., a 45 GHz or 60 GHz frequency band) and are capable of mmWave communications. Although the AP MLD 304 is shown in FIG. 3 as including five APs, other embodiments of the AP MLD 304 may include fewer than five APs or more than five APs. In addition, although the non-AP MLD 308 is shown in FIG. 3 as including five non-AP STAs, other embodiments of the non-AP MLD 308 may include fewer than five non-AP STAs or more than five non-AP STAs. In some embodiments, a STA in an IMMW link and an AP in an IMMW link are called or referred to as an IMMW STA and an IMMW AP, respectively.

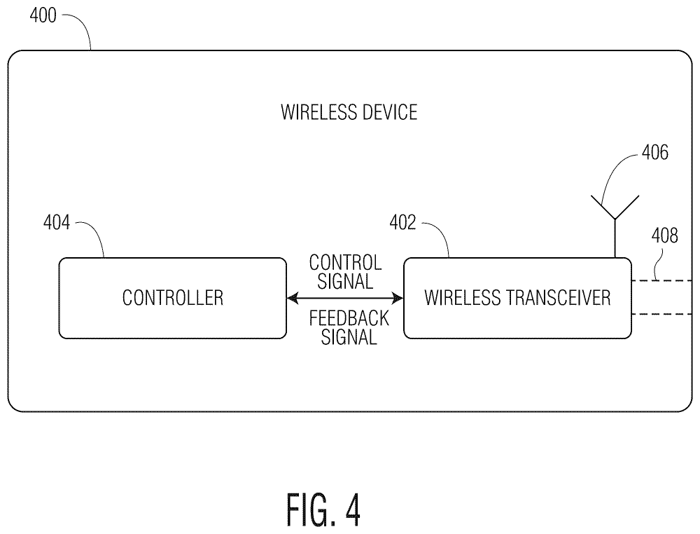

FIG. 4 depicts a wireless device 400 in accordance with an embodiment of the disclosure. The wireless device 400 can be used in the wireless communications system 100 depicted in FIG. 1, the multi-link communications system 200 depicted in FIG. 2, and/or the multi-link communications system 300 depicted in FIG. 3 for each link independently. For example, the wireless device 400 may be an embodiment of the AP 106 depicted in FIG. 1, the STA 110-1, . . . , 110-n depicted in FIG. 1, the APs 206-1, 206-2, 206-3 depicted in FIG. 2, the STAs 210-1, 210-2, 210-3 depicted in FIG. 2, the APs AP1, AP2, AP3, AP4, AP5 depicted in FIG. 3, and/or the STAs STA1, STA2, STA3, STA4, STA5 depicted in FIG. 3. In the embodiment depicted in FIG. 4, the wireless device 400 includes a wireless transceiver 402, a controller 404 operably connected to the wireless transceiver, and at least one antenna 406 operably connected to the wireless transceiver. In some embodiments, the wireless device 400 may include at least one network port 408 operably connected to the wireless transceiver. In some embodiments, the wireless transceiver includes a physical layer (PHY) device. The wireless transceiver may be any suitable type of wireless transceiver. For example, the wireless transceiver may be a LAN transceiver (e.g., a transceiver compatible with an IEEE 802.11 protocol). In some embodiments, the wireless device 400 includes multiple transceivers. The controller may be configured to control the wireless transceiver (e.g., by generating a control signal) to process packets received through the antenna and/or the network port and/or to generate outgoing packets to be transmitted through the antenna and/or the network port. In some embodiments, the wireless transceiver transmits one or more feedback signals to the controller. In some embodiments, the controller is implemented within a processor, such as a microcontroller, a host processor, a host, a DSP, or a CPU. In some embodiments, the wireless transceiver 402 is implemented in hardware (e.g., circuits), software, firmware, or a combination thereof. The antenna may be any suitable type of antenna. For example, the antenna may be an induction type antenna such as a loop antenna or any other suitable type of induction type antenna. However, the antenna is not limited to an induction type antenna. The network port may be any suitable type of port.

In accordance with an embodiment of the disclosure, the controller 404 is configured to generate a null data packet (NDP) beacon frame, where the NDP beacon frame contains information regarding a beam sector used to transmit information for helping integrated millimeter wave (IMMW) access point (AP) discovery and beam tracking, and the wireless transceiver 402 is configured to transmit the NDP beacon frame in an IMMW link, for example, through the at least one antenna 406.

In some embodiments, the information for helping the IMMW AP discovery and beam tracking in the NDP beacon frame contains an AP's identifier, remaining beacon information in a beacon burst, a beam identifier for transmitting the NDP beacon frame, information regarding partial timing synchronization function (TSF) time, and critical update indication information.

In some embodiments, the critical update indication information includes an indication regarding whether an access point (AP) multi-link device (MLD) or an AP affiliated with the AP MLD has a critical update. In some embodiments, a critical update of a device (e.g., an AP) includes at least one of the parameter update of DSO (dynamic subband operation), NPCA (non-primary channel access), DPS (dynamic power save), P-EDCA (prioritized enhanced distributed channel access), DBE (dynamic bandwidth extension bandwidth), AP's Periodic Unavailability Operation (PUO), dynamic unavailability operation (DUO). For example, the parameter update of AP's NPCA (non-primary channel access) includes NPCA enabling/disabling, NPCA primary channel, switch delay to NPCA primary channel, switch back delay to primary channel, NPCA channel puncture; the parameter update of AP's DSO (dynamic subband operation) includes enabling/disabling; the parameter update of AP's DBE (dynamic bandwidth extension bandwidth) includes DBE bandwidth, channel puncture information, the parameter update of AP's DPS (dynamic power save) includes enabling/disabling, Initial Control Frame (ICF) Required, DPS padding delay, DPS transition delay, bandwidth (BW), Number of Spatial Streams (Nss), Modulation Coding Scheme (MCS) in DPS low-capacity (LC) mode; the parameter update of AP's P-EDCA (prioritized enhanced distributed channel access) includes PEDCA (Priority-Enhanced Distributed Channel Access (EDCA)) CWmin (Contention Window Minimum), PEDCA CWmax (Contention Window Maximum), PEDCA AIFSN (Arbitration Inter-Frame Space Number) etc.

In some embodiments, instead of the critical update indication information, the indication whether the beacon in non-mmWave link needs to checked is carried in an NDP beacon frame.

In some embodiments, the wireless device 400 includes a wireless AP, and the AP's identifier includes a basic service set (BSS) color of the wireless AP.

In some embodiments, NDP beacon frames in the beacon burst are transmitted at each target beacon transmission time (TBTT) of the IMMW link.

In some embodiments, without a negotiation from either an associated non-AP multi-link device (MLD) or an unassociated station (STA) MLD, the NDP beacon frames in the beacon burst are transmitted using transmission beams agreed by associated STA MLDs.

In some embodiments, with a successful negotiation from either an associated non-AP multi-link device (MLD) or an unassociated station (STA) MLD, the NDP beacon frames in the beacon burst are transmitted using all transmission beams of an IMMW AP at a negotiated TBTT.

In some embodiments, the successful negotiation is performed by a non-AP MLD's NDP beacon request and an AP MLD's NDP beacon response with a successful indication that is solicited by the NDP beacon request.

In some embodiments, NDP beacon frames in the beacon burst are transmitted at a negotiated target beacon transmission time (TBTT) of the IMMW link.

In some embodiments, with a successful negotiation from either an associated non-AP multi-link device (MLD) or an unassociated station (STA) MLD, the NDP beacon frames in the beacon burst are transmitted using all transmission beams of an IMMW AP at the negotiated TBTT.

In some embodiments, the successful negotiation is performed by a non-AP MLD's NDP beacon request and an AP MLD's NDP beacon response with a successful indication that is solicited by the NDP beacon request.

In some embodiments, the wireless device 400 includes a wireless access point (AP) associated with an AP multi-link device (MLD), and the IMMW link is established between the AP MLD and a non-AP station (STA) MLD.

In some embodiments, the wireless device 400 includes a non-access point (AP) station (STA) associated with a non-AP STA multi-link device (MLD), and the IMMW link is established between the non-AP STA MLD and an AP MLD.

In some embodiments, the wireless transceiver 402 is further configured to schedule a transmission of NDP beacon frames periodically at each target beacon transmission time (TBTT) in the IMMW link, for example, through the at least one antenna 406.

In some embodiments, the wireless transceiver 402 is further configured to receive an NDP beacon request, transmit an NDP beacon response in response to the NDP beacon request, and transmit NDP beacon frames sequentially in a transmit opportunity (TXOP) through beams in the IMMW link at target beacon transmission time (TBTT) announced in the NDP beacon response, for example, through the at least one antenna 406.

In some embodiments, the wireless transceiver 402 is further configured to receive an NDP beacon request by the AP MLD, transmit an NDP beacon response by the AP MLD in response to the NDP beacon request, and transmit NDP beacon frames sequentially in a transmit opportunity (TXOP) through beams in the IMMW link at timing synchronization function (TSF) time announced in the NDP beacon response. In some embodiments, the wireless transceiver 402 is further configured to transmit an NDP beacon request by the non-AP MLD, receive an NDP beacon response by the non-AP MLD in response to the NDP beacon request. In some embodiments, only a non-AP MLD that is not associated with the AP MLD can transmit an NDP beacon request. In some embodiments, both an associated non-AP MLD and a non-AP MLD that is not associated with the AP MLD can transmit an NDP beacon request.

In some embodiments, the wireless transceiver 402 is further configured to schedule a transmission of NDP beacon frames in the IMMW link per the negotiation result through the NDP beacon request/response.

In some embodiments, without the NDP beacon transmission, at each TBTT of a mmWave link, the NDP Beacon is transmitted through the beam sectors that are agreed with the associated STA MLDs with the mmWave link; at the negotiated TBTT, the NDP Beacon is transmitted through all the beam sectors of the mm Wave AP of the AP MLD in the mmWave link. In some embodiments, without the NDP beacon transmission, at each TBTT, the NDP Beacon is not transmitted; at the negotiated TBTT, the NDP Beacon is transmitted through all the beam sectors of the mm Wave AP of the AP MLD in the mm Wave link.

In some embodiments, the NDP beacon frame includes a management frame that carries a channel number of each non-IMMW link of an access point (AP) multi-link device (MLD), a medium access control (MAC) address of the AP MLD, and an indication whether the AP MLD or an AP affiliated with the AP MLD has a critical update.

In some embodiments, the IMMW link includes a 45 Gigahertz (GHz) link or a 60 GHz link.

In some embodiments, the wireless device 400 is compatible with an Institute of Electrical and Electronics Engineers (IEEE) 802.11 protocol.

In some embodiments, a wireless access point (AP) multi-link device (MLD) includes a controller configured to generate a null data packet (NDP) beacon frame, where the NDP beacon frame contains AP identifier information, information regarding a beam sector used to transmit the NDP beacon frame, and beacon burst remaining time configured to transmit the NDP beacon frame(s) in an integrated millimeter wave (IMMW) link established between the wireless AP MLD and the non-AP station (STA) MLDs.

In some embodiments, the NDP beacon frame in an IMMW link is called or referred to as an NDP discovery assisting frame to figure out whether the AP transmitting the NDP frame can be reached through the IMMW link. In some embodiments, the NDP beacon frame is called or referred to as an NDP beam tracking frame. In some embodiments, the NDP beacon frame is called or referred to as an NDP discovery assisting and beam tracking frame.

Some implementations of NDP (Null Data Packet) Beacon: Beacon Definition, for example, by the STA/AP in a mmWave link of the wireless communications system 100 depicted in FIG. 1, the APs 206-1, 206-2, 206-3 in an mmWave link depicted in FIG. 2, the STAs 210-1, 210-2, 210-3 in an mmWave link depicted in FIG. 2, the APs AP1, AP2, AP3, AP4, AP5 in an mmWave link depicted in FIG. 3, and/or the STAs STA1, STA2, STA3, STA4, STA5 in an mmWave link depicted in FIG. 3, and/or the wireless device 400 depicted in FIG. 4 are described.

In some embodiments, a Null Data Packet (NDP) frame has a PHY header that carries the following information:
an IMMW AP's identifier, e.g., BSS color;
the beam sector being used to transmit the beacon;
the remaining Beacons being transmitted in this beacon burst or the remaining time until the end of this beacon burst;
Partial Timing Synchronization Function (TSF) time when the first bit of the field carrying the partial TSF time is in a specific processing procedure, e.g. the first bit of the field carrying the partial TSF time reaches the radio frequency (RF) connector; and
the indication whether an AP MLD or the APs affiliated with the AP MLD or any link of the AP MLD has a critical update.

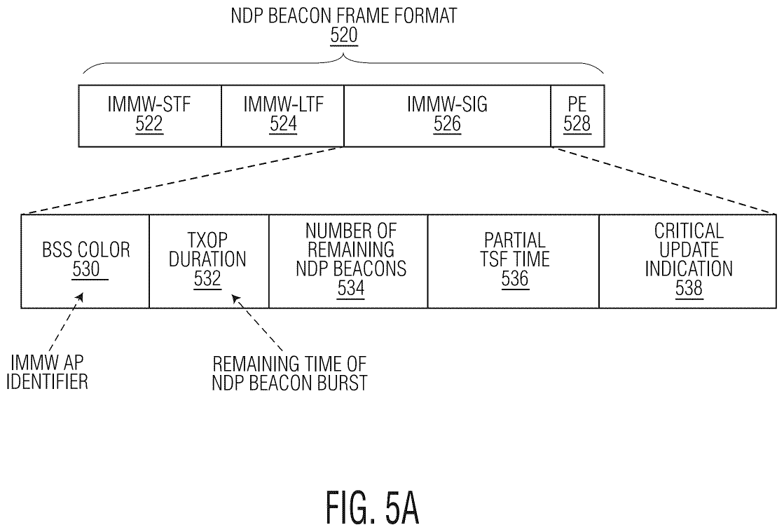

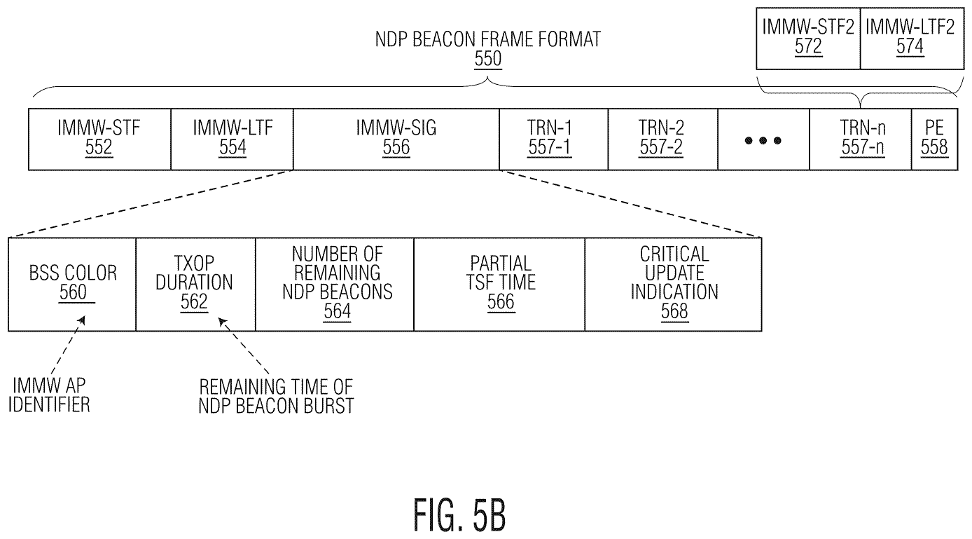

FIG. 5A illustrates a Null Data Packet (NDP) beacon frame format 520 in accordance with example embodiments. The NDP beacon frame format 520 illustrated in FIG. 5A can be used for communications by the STA/AP in the wireless communications system 100 depicted in FIG. 1, the IMMW APs 206-1, 206-2, 206-3 that transmit NDP Beacon frames depicted in FIG. 2, the STAs 210-1, 210-2, 210-3 that receive NDP Beacon frames depicted in FIG. 2, the IMMW APs AP1, AP2, AP3, AP4, AP5 that transmit NDP Beacon frames depicted in FIG. 3, and/or the IMMW STAs STA1, STA2, STA3, STA4, STA5 that receive NDP Beacon frames depicted in FIG. 3, and/or the wireless device 400 depicted in FIG. 4. In the embodiment depicted in FIG. 5A, the NDP beacon frame format 520 includes an IMMW-STF (Short Training Field) 522 that may contain packet detection, synchronization, and/or channel estimation information, an IMMW-LTF (Long Training Field) 524 that may contain IMMW channel estimation information, an IMMW-SIG (Signal) field 526 that may contain IMMW signal information, and a packet extension (PE) field 528 that may contain packet extension information. In some embodiments, the IMMW-SIG field 526 contains an IMMW AP's identifier subfield (e.g., BSS color) 530, a TXOP duration subfield 532 that may contain remaining time of an NDP beacon burst, a number of remaining NDP beacons subfield 534 that may contain the number of remaining beacons being transmitted in this Beacon transmission burst, a Partial Timing Synchronization Function (TSF) time subfield 536 that may contain partial TSF time information, and a critical update indication subfield 538 that may contain information regarding whether an AP MLD or the APs affiliated with the AP MLD has a critical update.

FIG. 5B illustrates an NDP beacon frame format 550 in accordance with example embodiments. The NDP beacon frame format 550 illustrated in FIG. 5B can be used for communications by the STA/AP in the wireless communications system 100 depicted in FIG. 1, the IMMW APs 206-1, 206-2, 206-3 that transmit NDP Beacon frames depicted in FIG. 2, the IMMW STAs 210-1, 210-2, 210-3 that receive NDP Beacon frames depicted in FIG. 2, the IMMW APs AP1, AP2, AP3, AP4, AP5 that transmit NDP Beacon frames depicted in FIG. 3, and/or the STAs STA1, STA2, STA3, STA4, STA5 that receive NDP Beacon frames depicted in FIG. 3, and/or the wireless device 400 depicted in FIG. 4. In the embodiment depicted in FIG. 5B, the NDP beacon frame format 550 includes an IMMW-STF 552 that may contain packet detection, synchronization, and/or channel estimation information, an IMMW-LTF 554 that may contain IMMW channel estimation information, an IMMW-SIG field 556 that may contain IMMW signal information, one or more training (TRN) fields 557-1, 557-2, . . . , 557-n that may contain channel estimation information and/or beam refinement information, where n is a positive integer, and a PE field 558 that may contain packet extension information. In some embodiments, the IMMW-SIG field 556 contains an IMMW AP's identifier subfield (e.g., BSS color) 560, a TXOP duration subfield 562 that may contain remaining time of an NDP beacon burst, a number of remaining NDP beacons subfield 564 that may contain the number of remaining beacons being transmitted in this Beacon burst, a Partial Timing Synchronization Function (TSF) time subfield 566 that may contain partial TSF time information, and a critical update indication subfield 568 that may contain information regarding whether an AP MLD or the APs affiliated with the AP MLD has a critical update. In some embodiments, the train field TRN-n 557-n includes an IMMW STF subfield 572 and an IMMW LTF subfield 574.

Some implementations of NDP (Null Data Packet) Beacon: Beacon Definition, for example, by the STA/AP in the wireless communications system 100 depicted in FIG. 1, the IMMW APs 206-1, 206-2, 206-3 depicted in FIG. 2, the IMMW STAs 210-1, 210-2, 210-3 depicted in FIG. 2, the IMMW APs AP1, AP2, AP3, AP4, AP5 depicted in FIG. 3, and/or the IMMW STAs STA1, STA2, STA3, STA4, STA5 depicted in FIG. 3, and/or the wireless device 400 depicted in FIG. 4 are described.

In some embodiments, an IMMW AP schedules the transmission of its beacons periodically. For at target beacon transmission time (TBTT), a group of beacons are transmitted through different beams (sectors) sequentially in a TXOP. In some embodiments, such beacons belong to a beacon burst. In some embodiments, for the periodic NDP beacon transmission, the associated IMMW STAs can perform the beam tracking using the periodic NDP beacons. In some embodiments, an unassociated non-AP MLD can figure out the TBTT and IMMW link channel of the IMMW AP affiliated with the same AP MLD as the equal to or lower than 7 GHZ (<=7 GHz) (non-IMMW) AP(s) through the non-IMMW AP(s). For example, the unassociated non-AP MLD may listen to the NDP beacon at the TBTT in the IMMW link to figure out whether it can reach the AP MLD in the IMMW link.

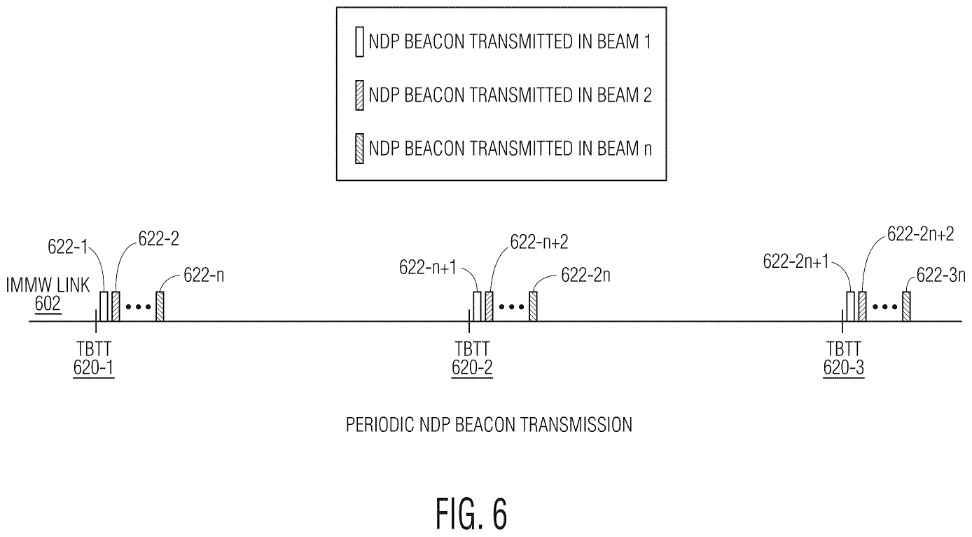

FIG. 6 illustrates a periodic NDP beacon transmission in accordance with example embodiments, which can be used by the IMMW STA/AP in the wireless communications system 100 depicted in FIG. 1, the IMMW APs 206-1, 206-2, 206-3 depicted in FIG. 2, the IMMW STAs 210-1, 210-2, 210-3 depicted in FIG. 2, the IMMW APs AP1, AP2, AP3, AP4, AP5 depicted in FIG. 3, and/or the IMMW STAs STA1, STA2, STA3, STA4, STA5 depicted in FIG. 3, and/or the wireless device 400 depicted in FIG. 4. In the periodic NDP beacon transmission illustrated in FIG. 6, NDP beacons 622-1, 622-2, . . . , 622-n (n being a positive integer) are transmitted in beams 1, 2, . . . , n of an IMMW link 602 after TBTT 620-1, NDP beacons 622-n+1, 622-n+2, . . . , 622-2n are transmitted in beams 1, 2, . . . , n of the IMMW link 602 after TBTT 620-2, and NDP beacons 622-2n+1, 622-2n+2, . . . , 622-3n are transmitted in beams 1, 2, . . . , n of the IMMW link 602 after TBTT 620-3.

Some implementations of NDP Beacon: On Demand Beacon with TBTT, for example, by the IMMW STA/AP in the wireless communications system 100 depicted in FIG. 1, the IMMW APs 206-1, 206-2, 206-3 depicted in FIG. 2, the IMMW STAs 210-1, 210-2, 210-3 depicted in FIG. 2, the IMMW APs AP1, AP2, AP3, AP4, AP5 depicted in FIG. 3, and/or the IMMW STAs STA1, STA2, STA3, STA4, STA5 depicted in FIG. 3, and/or the wireless device 400 depicted in FIG. 4 are described.

In some embodiments, when no request for NDP beacon transmission is received from an associated or unassociated non-AP MLD is received, an IMMW AP does not need to schedule the transmission of its beacons at each TBTT. In some embodiments, when no request for NDP beacon transmission from an associated or unassociated non-AP MLD is received, an IMMW AP schedules the transmission of its beacons at each TBTT where the beams used for transmitted the Beacons only covers the Tx beams agreed by the associated STAs. In some embodiments, the associated IMMW STA can periodically maintain its beam sector to the associated IMMW AP.

In some embodiments, if/when the request for NDP beacon transmission is received from the associated or unassociated non-AP MLD and accepted by the IMMW AP, the IMMW AP schedules the transmission of its beacons through all AP's Tx beams at the announced TBTT by the response. In some embodiments, one or several TBTTs may be used for transmitting such on-demand NDP beacons through all AP's Tx beams.

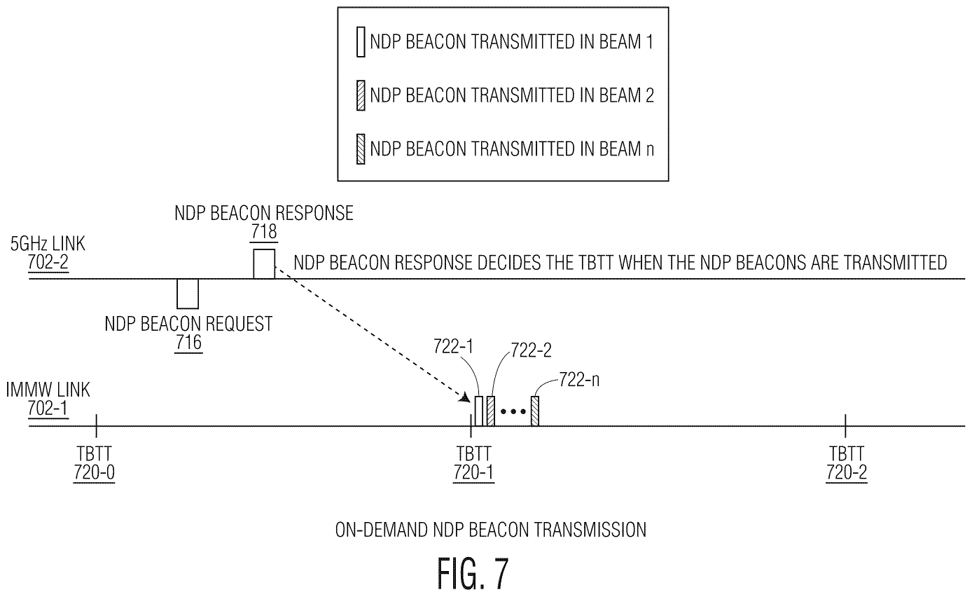

FIG. 7 illustrates an on-demand NDP beacon transmission in accordance with example embodiments, which can be used by the IMMW STA/AP in the wireless communications system 100 depicted in FIG. 1, the IMMW APs 206-1, 206-2, 206-3 depicted in FIG. 2, the IMMW STAs 210-1, 210-2, 210-3 depicted in FIG. 2, the IMMW APs AP1, AP2, AP3, AP4, AP5 depicted in FIG. 3, and/or the IMMW STAs STA1, STA2, STA3, STA4, STA5 depicted in FIG. 3, and/or the wireless device 400 depicted in FIG. 4. In the on-demand NDP beacon transmission illustrated in FIG. 7, an NDP beacon request 716 and a corresponding NDP beacon response 718, which decides, contains, or announces the TBTT when NDP beacons are transmitted, are transmitted in a 5 GHz link (non-IMMW link) 702-2. Subsequently, NDP beacons 722-1, 722-2, . . . , 722-n (n being a positive integer) are transmitted in beams 1, 2, . . . , n of an IMMW link 702-1 after TBTT 720-1 announced in the NDP beacon response 718. In some embodiments, one or several TBTTs 720-0, 720-1, 720-2 are used for transmitting such on-demand NDP beacons.

Some implementations of NDP Beacon: On Demand Beacon without TBTT, for example, by the IMMW STA/AP in the wireless communications system 100 depicted in FIG. 1, the IMMW APs 206-1, 206-2, 206-3 depicted in FIG. 2, the IMMW STAs 210-1, 210-2, 210-3 depicted in FIG. 2, the IMMW APs AP1, AP2, AP3, AP4, AP5 depicted in FIG. 3, and/or the IMMW STAs STA1, STA2, STA3, STA4, STA5 depicted in FIG. 3, and/or the wireless device 400 depicted in FIG. 4 are described.

In some embodiments, when no request for NDP beacon transmission is received from an associated or unassociated non-AP MLD is received, the IMMW AP does not need to schedule the transmission of its NDP beacons. In some embodiments, if/when the request for NDP beacon transmission is received from the associated or unassociated non-AP MLD, the IMMW AP schedules the transmission of its beacons at the TSF time announced by an NDP beacon response. In some embodiments, if/when the request for NDP beacon transmission is received from the associated or unassociated non-AP MLD and accepted by the IMMW AP, the IMMW AP schedules the transmission of its beacons through all AP's Tx beams at the agreed TSF time by the response.

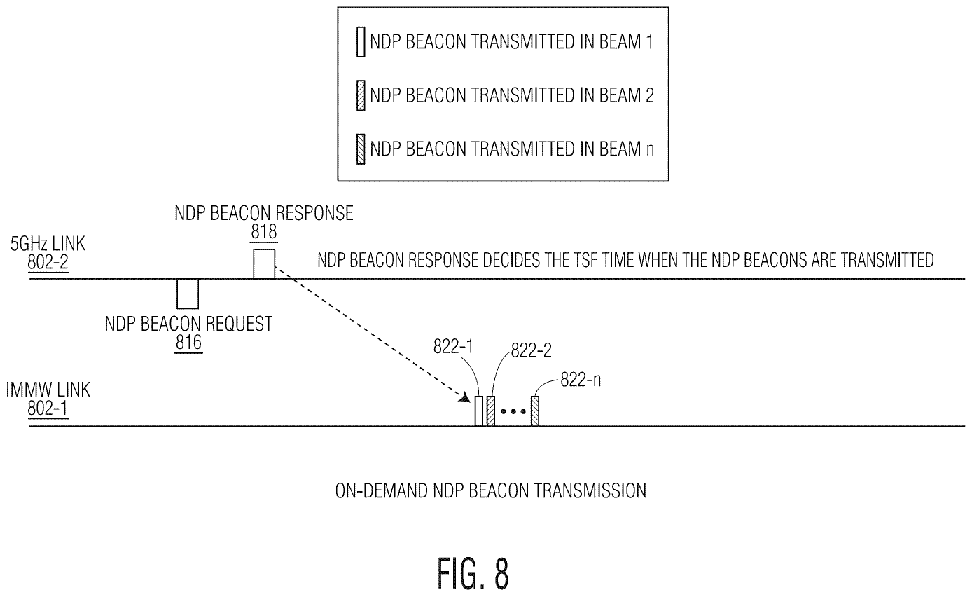

FIG. 8 illustrates an on-demand NDP beacon transmission in accordance with example embodiments, which can be used by the STA/AP in the wireless communications system 100 depicted in FIG. 1, the IMMW APs 206-1, 206-2, 206-3 depicted in FIG. 2, the IMMW STAs 210-1, 210-2, 210-3 depicted in FIG. 2, the IMMW APs AP1, AP2, AP3, AP4, AP5 depicted in FIG. 3, and/or the IMMW STAs STA1, STA2, STA3, STA4, STA5 depicted in FIG. 3, and/or the wireless device 400 depicted in FIG. 4. In the on-demand NDP beacon transmission illustrated in FIG. 8, an NDP beacon request 816 and a corresponding NDP beacon response 818, which may decide, contain, or announce the (partial) TSF time when NDP beacons are transmitted, are transmitted in a 5 GHz link (non-IMMW link) 802-2. Subsequently, NDP beacons 822-1, 822-2, . . . , 822-n (n being a positive integer) are transmitted in beams 1, 2, . . . , n of an IMMW link 802-1, for example, at the (partial) TSF time announced in the NDP beacon response 818.

Some implementations of NDP Beacon: Beacon Definition and Transmission, for example, by the IMMW STA/AP in the wireless communications system 100 depicted in FIG. 1, the IMMW APs 206-1, 206-2, 206-3 depicted in FIG. 2, the STAs 210-1, 210-2, 210-3 depicted in FIG. 2, the IMMW APs AP1, AP2, AP3, AP4, AP5 depicted in FIG. 3, and/or the IMMW STAs STA1, STA2, STA3, STA4, STA5 depicted in FIG. 3, and/or the wireless device 400 depicted in FIG. 4 are described.

In some embodiments, when an IMMW AP schedules the transmission of its NDP beacons, e.g., at TBTT, a group of NDP beacons are transmitted through different beam sectors sequentially in a TXOP. In some embodiments, such beacons belong to a beacon burst.

In some embodiments, the light beacon is used instead of NDP Beacon and the light Beacon is a management frame that carries the following information:
the channel number of each non-IMMW link of the AP MLD;
the AP MLD MAC address; and
the indication whether the AP MLD or the APs affiliated with the AP MLD have critical update etc.

Some implementations of Light Beacon: Periodic Beacon Transmission, for example, by the IMMW STA/AP in the wireless communications system 100 depicted in FIG. 1, the IMMW APs 206-1, 206-2, 206-3 depicted in FIG. 2, the IMMW STAs 210-1, 210-2, 210-3 depicted in FIG. 2, the IMMW APs AP1, AP2, AP3, AP4, AP5 depicted in FIG. 3, and/or the IMMW STAs STA1, STA2, STA3, STA4, STA5 depicted in FIG. 3, and/or the wireless device 400 depicted in FIG. 4 are described.

In some embodiments, at each TBTT, an IMMW AP schedules the transmission of its light beacons of a beacon burst in an IMMW link.

In some embodiments, an unassociated non-AP MLD may try to detect the light beacons in an IMMW channel without the help of an AP MLD's non-IMMW link.

In some embodiments, an associated non-AP MLD may receive the light beacon in an IMMW link instead of receiving beacons in a non-IMMW link.

In some embodiments, a method of transmitting beacon by a first device in its IMMW link to a second device with the IMMW link includes transmitting, by the first device, in the IMMW link, the Beacon frame, and receiving, by the second device, the beacon frame in the IMMW link. In some embodiments, the second device notifies the first device through a non-IMMW link its intention to receive the beacon in the first device's IMMW link. In some embodiments, the first device announces through a non-IMMW link when to transmit its beacon in its IMMW link. In some embodiments, the first device schedules its beacon transmission at the announced time in its IMMW link. In some embodiments, the second device prepares the beacon reception/detection at the announced time in the first device's IMMW link. In some embodiments, a group of beacons are sequentially transmitted within a Short Interframe Space (SIFS). In some embodiments, the beacon carries the IMMW AP's identifier, beam sector being used to transmit the beacon, the remaining beacons within an SIFS.

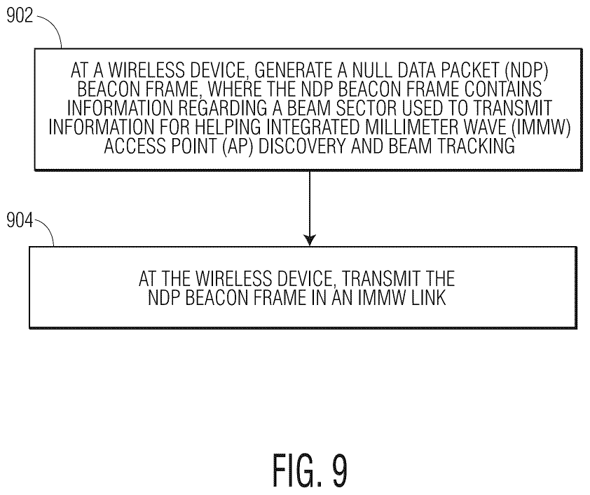

FIG. 9 is a process flow diagram of a method for wireless communications in accordance with example embodiments. At block 902, at a wireless device, one or multiple null data packet (NDP) beacons frame is/are generated by an IMMW AP, where the NDP beacon frame contains information regarding a beam sector used to transmit information for helping integrated millimeter wave (IMMW) access point (AP) discovery and beam tracking. At block 904, at the wireless device, each NDP beacon frame is transmitted to the STAs in an integrated millimeter wave (IMMW) link. In some embodiments, the information for helping the IMMW AP discovery and beam tracking in the NDP beacon frame contains an AP's identifier, remaining beacon information in a beacon burst, a beam identifier for transmitting the NDP beacon frame, information regarding partial timing synchronization function (TSF) time, and critical update indication information. In some embodiments, the critical update indication information comprises an indication regarding whether an access point (AP) multi-link device (MLD) or an AP affiliated with the AP MLD has a critical update. In some embodiments, the wireless device includes a wireless AP, and the AP's identifier includes a basic service set (BSS) color of the wireless AP. In some embodiments, NDP beacon frames in the beacon burst are transmitted at each target beacon transmission time (TBTT) of the IMMW link. In some embodiments, without a negotiation from either an associated non-AP multi-link device (MLD) or an unassociated station (STA) MLD, the NDP beacon frames in the beacon burst are transmitted using transmission beams agreed by associated STA MLDs. The wireless device may be the same as or similar to an embodiment of the IMMW STA 110-1, . . . , or 110-n and/or the IMMW AP 106 depicted in FIG. 1, the IMMW APs 206-1, 206-2, 206-3 depicted in FIG. 2, the IMMW STAs 210-1, 210-2, 210-3 depicted in FIG. 2, the IMMW APs AP1, AP2, AP3, AP4, AP5 depicted in FIG. 3, and/or the IMMW STAs STA1, STA2, STA3, STA4, STA5 depicted in FIG. 3, and/or the wireless device 400 depicted in FIG. 4.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods described herein may be implemented using software instructions stored on a computer useable storage medium for execution by a computer. As an example, an embodiment of a computer program product includes a computer useable storage medium to store a computer readable program.

The computer-useable or computer-readable storage medium can be an electronic, magnetic, optical, electromagnetic, infrared, or semiconductor system (or apparatus or device). Examples of non-transitory computer-useable and computer-readable storage media include a semiconductor or solid-state memory, magnetic tape, a removable computer diskette, a random-access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Alternatively, embodiments of the disclosure may be implemented entirely in hardware or in an implementation containing both hardware and software elements. In embodiments which use software, the software may include but is not limited to firmware, resident software, microcode, etc.

Although specific embodiments of the disclosure have been described and illustrated, the disclosure is not to be limited to the specific forms or arrangements of parts so described and illustrated. The scope of the claims is to be defined by the claim language and their equivalents.

What is claimed is:

1. A wireless device comprising:
a controller configured to generate a null data packet (NDP) beacon frame, wherein the NDP beacon frame contains information regarding a beam sector used to transmit information for helping integrated millimeter wave (IMMW) access point (AP) discovery and beam tracking; and
a wireless transceiver configured to transmit the NDP beacon frame in an IMMW link.

2. The wireless device of claim 1, wherein the information for helping the IMMW AP discovery and beam tracking in the NDP beacon frame contains an AP's identifier, remaining beacon information in a beacon burst, a beam identifier for transmitting the NDP beacon frame, information regarding partial timing synchronization function (TSF) time, and critical update indication information.

3. The wireless device of claim 2, wherein the critical update indication information comprises an indication regarding whether an access point (AP) multi-link device (MLD) or an AP affiliated with the AP MLD has a critical update.

4. The wireless device of claim 2, wherein the wireless device comprises a wireless AP, and wherein the AP's identifier comprises a basic service set (BSS) color of the wireless AP.

5. The wireless device of claim 2, wherein a plurality of NDP beacon frames in the beacon burst are transmitted at each target beacon transmission time (TBTT) of the IMMW link.

6. The wireless device of claim 5, wherein without a negotiation from either an associated non-AP multi-link device (MLD) or an unassociated station (STA) MLD, the NDP beacon frames in the beacon burst are transmitted using a plurality of transmission beams agreed by a plurality of associated STA MLDs.

7. The wireless device of claim 5, wherein with a successful negotiation from either an associated non-AP multi-link device (MLD) or an unassociated station (STA) MLD, the NDP beacon frames in the beacon burst are transmitted using all transmission beams of an IMMW AP at a negotiated TBTT.

8. The wireless device of claim 7, wherein the successful negotiation is performed by a non-AP MLD's NDP beacon request and an AP MLD's NDP beacon response with a successful indication that is solicited by the NDP beacon request.

9. The wireless device of claim 2, wherein a plurality of NDP beacon frames in the beacon burst are transmitted at a negotiated target beacon transmission time (TBTT) of the IMMW link.

10. The wireless device of claim 9, wherein with a successful negotiation from either an associated non-AP multi-link device (MLD) or an unassociated station (STA) MLD, the NDP beacon frames in the beacon burst are transmitted using all transmission beams of an IMMW AP at the negotiated TBTT.

11. The wireless device of claim 10, wherein the successful negotiation is performed by a non-AP MLD's NDP beacon request and an AP MLD's NDP beacon response with a successful indication that is solicited by the NDP beacon request.

12. The wireless device of claim 1, wherein the IMMW link comprises a 45 Gigahertz (GHz) link or a 60 GHz link.

13. The wireless device of claim 1, wherein the wireless device is compatible with an Institute of Electrical and Electronics Engineers (IEEE) 802.11 protocol.

14. A wireless access point (AP) multi-link device (MLD) comprising:
a controller configured to generate a null data packet (NDP) beacon frame, wherein the NDP beacon frame contains AP identifier information, information regarding a beam sector used to transmit the NDP beacon frame, and beacon burst remaining beacon frame information; and
a wireless transceiver configured to transmit the NDP beacon frame in an integrated millimeter wave (IMMW) link established between the wireless AP MLD and a non-AP station (STA) MLD.

15. A method for wireless communications, the method comprising:
at a wireless device, generating a null data packet (NDP) beacon frame, wherein the NDP beacon frame contains information regarding a beam sector used to transmit information for helping integrated millimeter wave (IMMW) access point (AP) discovery and beam tracking; and
at the wireless device, transmitting the NDP beacon frame in an IMMW link.

16. The method of claim 15, wherein the information for helping the IMMW AP discovery and beam tracking in the NDP beacon frame contains an AP's identifier, remaining beacon information in a beacon burst, a beam identifier for transmitting the NDP beacon frame, information regarding partial timing synchronization function (TSF) time, and critical update indication information.

17. The method of claim 16, wherein the critical update indication information comprises an indication regarding whether an access point (AP) multi-link device (MLD) or an AP affiliated with the AP MLD has a critical update.

18. The method of claim 16, wherein the wireless device comprises a wireless AP, and wherein the AP's identifier comprises a basic service set (BSS) color of the wireless AP.

19. The method of claim 16, wherein a plurality of NDP beacon frames in the beacon burst are transmitted at each target beacon transmission time (TBTT) of the IMMW link.

20. The method of claim 19, wherein without a negotiation from either an associated non-AP multi-link device (MLD) or an unassociated station (STA) MLD, the NDP beacon frames in the beacon burst are transmitted using a plurality of transmission beams agreed by a plurality of associated STA MLDs.
